(19) United States
(12) Patent Application Publication
(10) Pub. No.: US 2019/0140548 A1
(43) Pub. Date: May 9, 2019

(54) Power-Packet-Switching Circuits Using Stacked Bidirectional Switches

(71) Applicant: Ideal Power Inc., Austin, TX (US)

(72) Inventor: William C. Alexander, Spicewood, TX (US)

(73) Assignee: Ideal Power Inc., Austin, TX (US)

(21) Appl. No.: 16/043,945

(22) Filed: Jul. 24, 2018

Related U.S. Application Data
(63) Continuation of application No. PCT/US16/69617, filed on Dec. 30, 2016.
(60) Provisional application No. 62/329,876, filed on Apr. 29, 2016.

(51) Int. Cl. H02M 3/335; H02M 1/08

(52) U.S. Cl. CPC H02M 3/33584; H02M 1/083

(57) ABSTRACT

Power-packet-switching circuits (and methods and systems) in which at least one port uses series-connected combinations of bidirectional switches to connect a link inductor (or transformer), with selectable polarity, to an outside line. Optionally, series-connected combinations of bidirectional switches are used for phase legs in some ports, while single bidirectional switches are used for the phase legs in other ports. This can be particularly advantageous where the converter interfaces between lines at significantly different operating voltages. By using B-TRANs as the series-combined elements of the combinations of switches, voltage-dividing circuitry is not needed to equalize the voltages seen by the individual devices in each combination.

### CROSS-REFERENCE

Priority is claimed from U.S. 62/329,876, which is hereby incorporated by reference.

### BACKGROUND

The present application relates to power-packet-switching power converters.

Note that the points discussed below may reflect the hindsight gained from the disclosed inventions, and are not necessarily admitted to be prior art.

A new kind of power converter was disclosed in U.S. Pat. No. 7,599,196 entitled “Universal power conversion methods,” which is incorporated by reference into the present application in its entirety. This patent describes a bidirectional (or multidirectional) power converter which pumps power into and out of a link inductor which is shunted by a capacitor.

The switch arrays at the ports are operated to achieve zero-voltage switching by totally isolating the link inductor+capacitor combination at times when its voltage is desired to be changed. (When the inductor+capacitor combination is isolated at such times, the inductor's current will change the voltage of the capacitor, as in a resonant circuit. This can even change the sign of the voltage, without loss of energy.) This architecture is now referred to as a “current-modulating”or “Power Packet Switching” architecture. Bidirectional power switches are used to provide a full bipolar (reversible) connection from each of multiple lines, at each port, to the rails, i.e. the internal lines across which the link inductor and its capacitor are connected.

Note that the U.S. Pat. No. 7,599,196 explicitly contemplated, e.g. in FIG. 22, that the PPSA's link inductor could be implemented as a link transformer. That example showed a two-port converter, in which each port can be AC or DC. The terminology used in that application is slightly different, but in the terminology of the present application, the circuitry to the left of the transformer would be referred to as one port including two phase legs, each of which includes two bidirectional switches; the circuitry to the right of the transformer would be referred to as another port, including two more phase legs. Thus as illustrated there, a converter with two DC ports would presumably be implemented with four phase legs, or a total of 8 bidirectional switches. (The bidirectional switches are each shown as an opposed pair of IGBTs, but of course other solid-state switch implementations can be used.)

As taught in previous commonly-owned applications, the B-TRAN is usually operated with diode-mode switching phases before and after the period of minimum on-state voltage drop. The diode-mode switching phases impose a larger voltage drop—e.g. about a Volt in silicon, as opposed to a very few tenths of a volt under full bipolar conduction. These diode-mode switching phases help to assure stable transition into and out of the periods of full bipolar conduction.

The B-TRAN can scale to higher breakdown voltages by increasing the thickness, and/or reducing the doping, of the semiconductor substrate. However, scaling also tends to reduce switching speed.

### Power-Packet-Switching Circuits Using Stacked Bidirectional Switches

The present application teaches, among other innovations, power-packet-switching circuits in which at least one port uses series-connected combinations of bidirectional switches to connect a link inductor to an outside line. Thus a single phase leg (connected to a single line of an outside port) would typically be expected to include two separate series-connected combinations of bidirectional switches: one to selectably connect the outside line to one terminal of the link inductor, and one to selectably connect the same outside line to the other terminal of the link inductor.

In some but not all implementations, series-connected combinations of bidirectional switches are used for connection to some ports, while single bidirectional switches are used to connect to other ports.

In some but not all implementations, the link inductor is a transformer, and series-connected combinations of bidirectional switches are used for phase legs in some ports, while single bidirectional switches are used for the phase legs in other ports. This can be particularly advantageous where the converter interfaces between lines at significantly different operating voltages.

In some but not all implementations, series-connected combinations of bidirectional switches are used for connection to some ports, without any voltage-dividing circuitry to equalize the voltages seen by the individual devices in each combination.

Series-connected combinations of switches have been used for switching medium or high voltages. However, such configurations usually require special measures to equalize the off-state voltage drop across the individual devices, and/or to synchronize turn-on and/or turn-off. Off-state voltage equalization can be implemented, for example, by a resistive voltage divider, as shown in FIG. 3.

The present inventor has realized that the PPSA architecture combines synergistically with the use of stacked devices. Since the PPSA architecture inherently provides zero-voltage switching, turn-on and turn-off are simplified. Conventional, hard switched converters typically have switches turn on into a high forward voltage. This is difficult to accomplish using switches in series, since the switches cannot be turned on at exactly the same time, leaving the last switch still on supporting the entire bus voltage, which will damage that last switch. In the PPSA, switches never turn on into forward voltage, so there is no difficulty turning on two or more switches in series.

In some but not all embodiments, this capability is used on only the higher-voltage ports of a converter which connects to ports at different voltages. For example, where a converter is used to drive a 2400V motor from a 480V line, switches rated at e.g. 1200V might be sufficient for the pull-up and pull-down devices in each of the legs on the 480V side, whereas a stack of six such switches, with a capacitive voltage divider, can be used on the 2400V side. In such cases a link transformer is preferably used as the link inductor, with a turns ratio matching the voltage ratings (or device ratings) on the two kinds of ports.

A further optional teaching is that the voltage divider can be simplified or eliminated. In one class of embodiments, the stacked devices are operated without any voltage divider. In another class of embodiments, a capacitor ladder is used to provide a capacitive voltage divider. Unlike a resistive voltage divider, this does not have any static power dissipation.

This is particularly synergistic when the bidirectional switches in a PPSA are implemented as “B-TRAN” switches. The B-TRAN is a relatively new power switching device, in which two emitter/collector regions are provided on two opposite faces of a semiconductor mass, and two base contact regions are provided on the two faces respectively. The two base contact regions are not tied together, but are operated independently to provide a combination of low on-state resistance and relatively high current gain. Since conduction is bipolar, the B-TRAN allows a very low forward voltage; at the same time, the B-TRAN also provides a high breakdown voltage in relation to the power switched.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 schematically shows one example implementation, where stacked bidirectional switches are used on both ports of a two-port power converter.

FIG. 2 shows another example implementation, where stacked bidirectional switches are used on one side of a transformer-coupled two-port power converter.

FIG. 3 shows one phase leg of another sample implementation, where a resistive ladder is used to control the voltage drops in stacked bidirectional switches in a two-port power converter.

FIG. 4 shows another sample implementation similar to that of FIG. 1 which uses a resistive ladder like that of FIG. 3.

FIG. 5 shows yet another sample implementation, where stacked bidirectional switches are used on both sides of a transformer-coupled two-port power converter.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The present application discloses new approaches to power-packet-switching power conversion.

The present application teaches, among other innovations, power-packet-switching circuits in which at least one port uses series-connected combinations of bidirectional switches to connect a link inductor to an outside line. Thus a single phase leg (connected to a single line of an outside port) would typically be expected to include two separate series-connected combinations of bidirectional switches: one to selectably connect the outside line to one terminal of the link inductor, and one to selectably connect the same outside line to the other terminal of the link inductor. Since two combinations are present in such a phase leg, at least four switches are necessarily present in one phase leg.

In some but not all implementations, series-connected combinations of bidirectional switches are used for connection to some ports, while single bidirectional switches are used to connect to other ports.

In some but not all implementations, the link inductor is a transformer, and series-connected combinations of bidirectional switches are used for phase legs in some ports, while single bidirectional switches are used for the phase legs in other ports. This can be particularly advantageous where the converter interfaces between lines at significantly different operating voltages.

In some but not all implementations, series-connected combinations of bidirectional switches are used for connection to some ports, without any voltage-dividing circuitry to equalize the voltages seen by the individual devices in each combination.

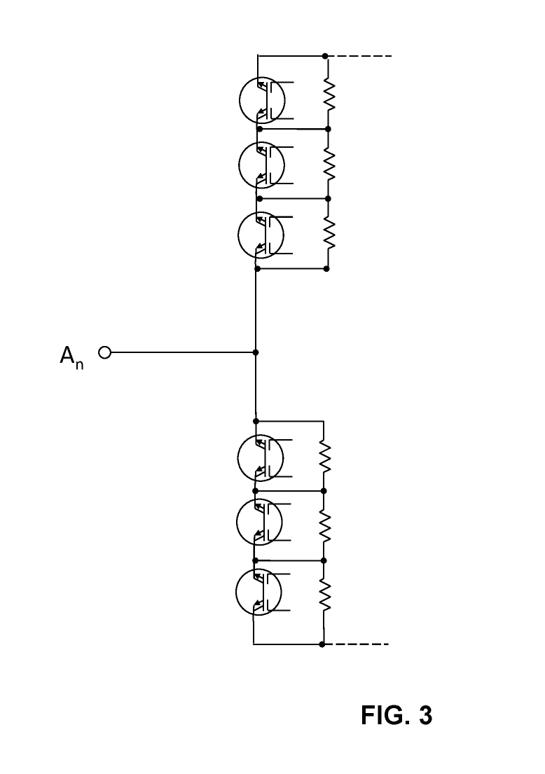

Series-connected combinations of switches have been used for switching medium or high voltages. However, such configurations usually require special measures to equalize the off-state voltage drop across the individual devices, and/or to synchronize turn-on and/or turn-off. Off-state voltage equalization can be implemented, for example, by a resistive voltage divider, as shown in FIG. 3.

The present inventor has realized that the PPSA architecture combines synergistically with the use of stacked devices. Since the PPSA architecture inherently provides zero-voltage switching, turn-on and turn-off are simplified. Conventionally, hard switched converters typically have switches turn on into a high forward voltage. This is difficult to accomplish using switches in series, since the switches cannot be turned on at exactly the same time, leaving the last switch still on supporting the entire bus voltage, which will damage that last switch. In the PPSA, switches never turn on into forward voltage, so there is no difficulty turning on two or more switches in series.

In some but not all embodiments, this capability is used on only the higher-voltage ports of a converter which connects to ports at different voltages. For example, where a converter is used to drive a 2400V motor from a 480V line, switches rated at e.g. 1200V might be sufficient for the pull-up and pull-down devices in each of the legs on the 480V side, whereas a stack of six such switches, with a capacitive voltage divider, can be used on the 2400V side. In such cases a link transformer is preferably used as the link inductor, with a turns ratio matching the voltage ratings (or device ratings) on the two kinds of ports.

A further optional teaching is that the voltage divider can be simplified or eliminated. In one class of embodiments, the stacked devices are operated without any voltage divider. In another class of embodiments, a capacitor ladder is used to provide a capacitive voltage divider. Unlike a resistive voltage divider, this does not have any static power dissipation.

This is particularly synergistic when the bidirectional switches in a PPSA are implemented as “B-TRAN” switches. The B-TRAN is a relatively new power switching device, in which two emitter/collector regions are provided on two opposite faces of a semiconductor mass, and two base contact regions are provided on the two faces respectively. The two base contact regions are not tied together, but are operated independently to provide a combination of low on-state resistance and relatively high current gain. Since conduction is bipolar, the B-TRAN allows a very low forward voltage; at the same time, the B-TRAN also provides a high breakdown voltage in relation to the power switched.

As taught in previous commonly-owned applications, the B-TRAN is usually operated with diode-mode switching phases before and after the period of minimum on-state voltage drop. The diode-mode switching phases impose a larger voltage drop—e.g. about a Volt in silicon, as opposed to a very few tenths of a volt under full bipolar conduction. These diode-mode switching phases help to assure stable transition into and out of the periods of full bipolar conduction. However, a secondary benefit is that two B-TRANs can be operated in series with the same base drive signals, and the diode-mode switching phase help to stabilize the transition of the series combination of the two B-TRANs into and out of the period of minimum voltage drop.

The B-TRAN can scale to higher breakdown voltages by increasing the thickness, and/or reducing the doping, of the semiconductor substrate. However, scaling also tends to reduce switching speed. Thus a further advantage of using a series-connected-combination of B-TRANs is that the switching speed of a series combination can be faster than that which a single B-TRAN at the higher voltage would have.

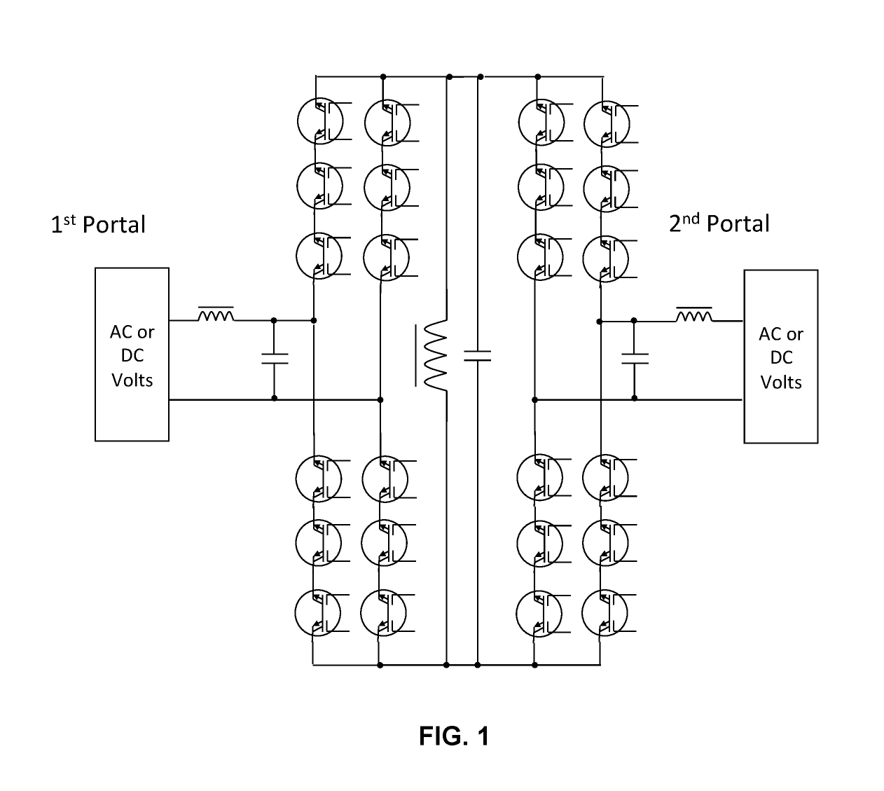

FIG. 1 schematically shows one example implementation, where six stacked bidirectional switches are used on both ports of a two-port power converter. The individual switches, in this example, are B-TRAN devices. The two gates are controlled to implement the sequence of switching phases described in previous B-TRAN applications.

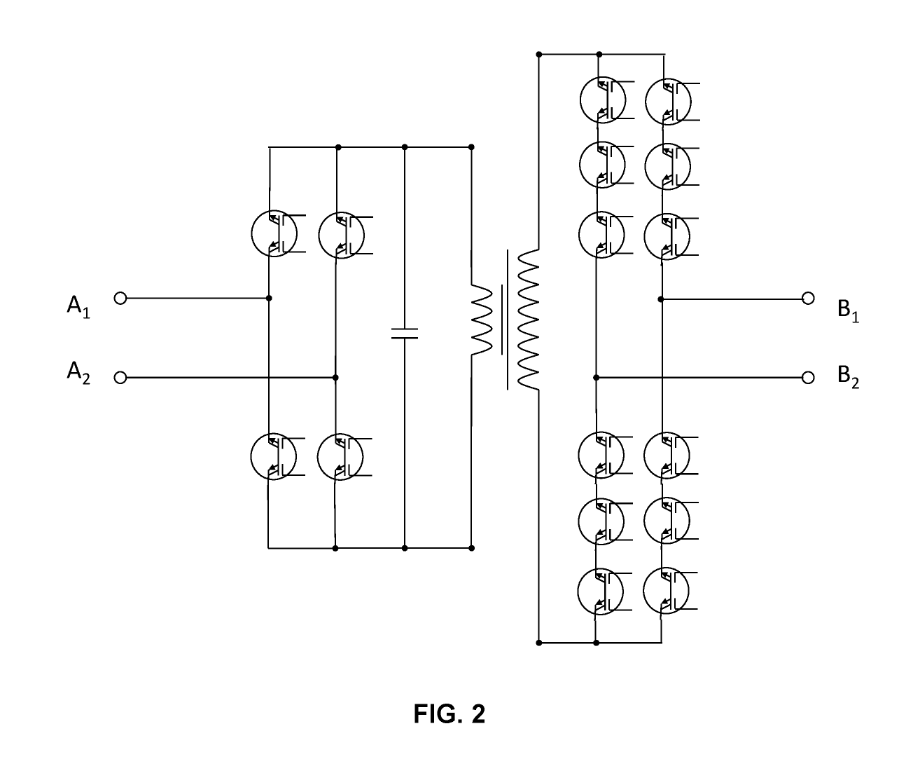

FIG. 2 shows another example implementation, where six stacked bidirectional switches are used on one side of a transformer-coupled two-port power converter. The transformer coupling will inherently provide more isolation, and can also be used to provide different voltage interfacing on the two sides of the transformer.

FIG. 3 shows one phase leg of another sample implementation, where a resistive ladder is used to control the voltage drops in stacked bidirectional switches in a two-port power converter. This implementation is less preferred, but still can provide advantages.

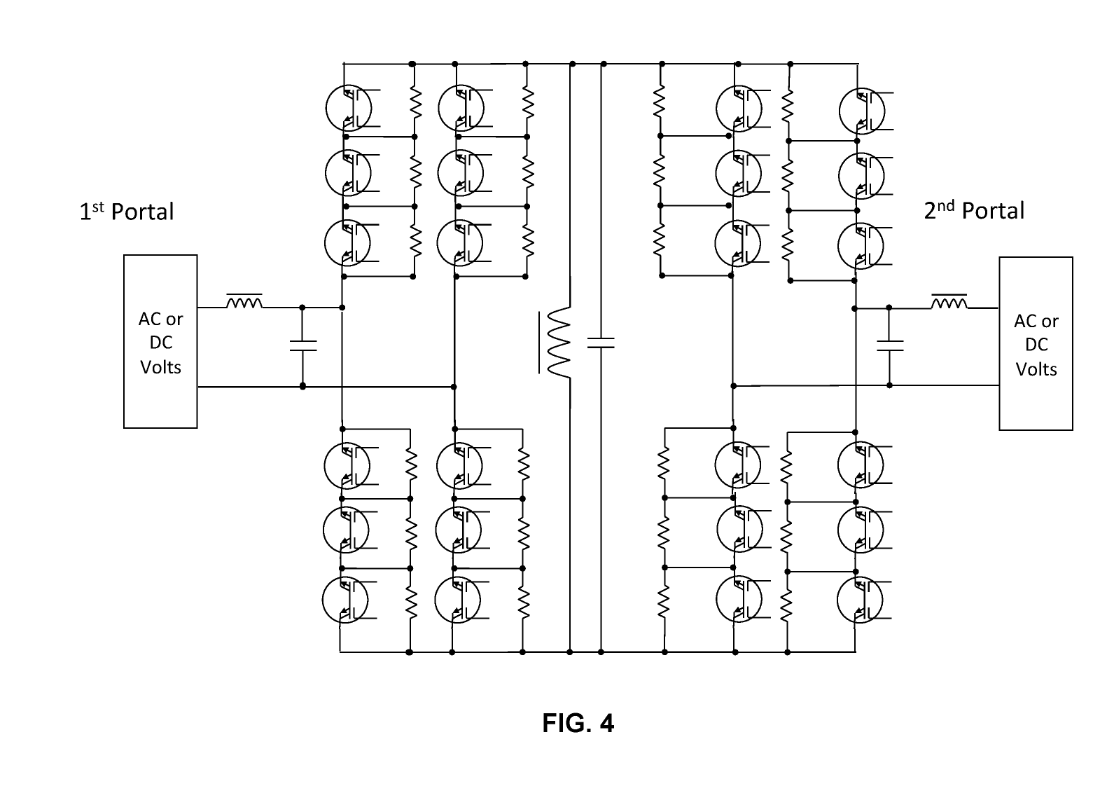

FIG. 4 shows another sample implementation similar to that of FIG. 1 which uses a resistive ladder like that of FIG. 3. This implementation is less preferred, but still can provide advantages.

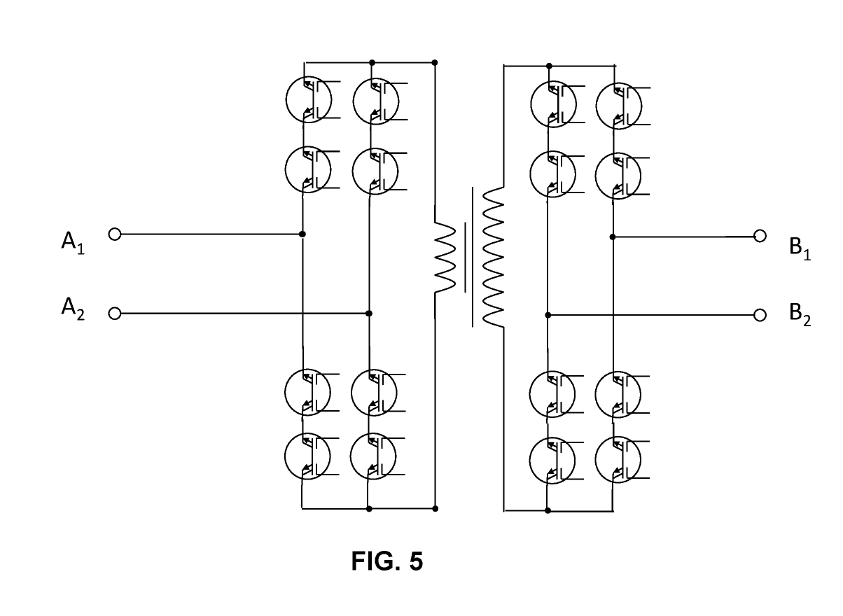

FIG. 5 shows yet another sample implementation, where stacked bidirectional switches are used on both sides of a transformer-coupled two-port power converter. Here, four stacked bidirectional switches are used on each phase leg. Again, this implementation is somewhat less preferred, but still can provide advantages.

### Advantages

The disclosed innovations, in various embodiments, provide one or more of at least the following advantages. However, not all of these advantages result from every one of the innovations disclosed, and this list of advantages does not limit the various claimed inventions.
Improved efficiency in power conversion systems;
Power conversion systems with more ruggedness;
Power conversion systems with higher breakdown voltage;
Power conversion systems with lower on-resistance:
Power conversion systems with lower cost.

According to some but not necessarily all embodiments, there is provided: Power-packet-switching circuits (and methods and systems) in which at least one port uses series-connected combinations of bidirectional switches to connect a link inductor (or transformer), with selectable polarity, to an outside line. Optionally, series-connected combinations of bidirectional switches are used for phase legs in some ports, while single bidirectional switches are used for the phase legs in other ports. This can be particularly advantageous where the converter interfaces between lines at significantly different operating voltages. By using B-TRANs as the series-combined elements of the combinations of switches, voltage-dividing circuitry is not needed to equalize the voltages seen by the individual devices in each combination.

According to some but not necessarily all embodiments, there is provided: A power conversion method, comprising the repeated actions of: a1) totally disconnecting a link inductor from external connections, to thereby change the voltage of the link inductor; and then a2) driving energy into the link inductor using a first phase leg, which includes a bidirectional switch selectably connecting a respective outside line to a first terminal of the link inductor, and also another bidirectional switch selectably connecting the same outside line to a second terminal of the link inductor; b1) totally disconnecting the link inductor from external connections, to thereby again change the voltage of the link inductor; and then b2) extracting energy from the link inductor through a second phase leg, which includes bidirectional switches selectably connecting another respective outside line to the first or second terminals of the link inductor; wherein step a1 is prolonged sufficiently that turn-on at the start of step a2 happens under approximately zero voltage; and wherein step b1 is prolonged sufficiently that turn-off at the start of step b2 happens under approximately zero voltage; wherein at least one of the phase legs includes two series-connected combinations of bidirectional switches, which are connected to be switched in synchrony.

According to some but not necessarily all embodiments, there is provided: A power conversion method, comprising the repeated actions of: a1) totally disconnecting a link transformer from the outside world, to thereby change the voltage across windings of the link transformer; and then a2) driving energy into the link transformer using a first phase leg, which includes a bidirectional switch selectably connecting a respective outside line to a first terminal of the link transformer, and also another bidirectional switch selectably connecting the same outside line to a second terminal of the link transformer; b1) totally disconnecting the link transformer from the outside world, to thereby again change the voltage of the link transformer; and then b2) extracting energy from the link transformer through a second phase leg, which includes two bidirectional switches selectably connecting another respective outside line to selectable terminals of the link transformer; wherein step a1 is prolonged sufficiently that turn-on at the start of step a2 happens under approximately zero voltage; and wherein step b1 is prolonged sufficiently that turn-off at the start of step b2 happens under approximately zero voltage; and wherein at least one of the phase legs, but not both, includes two series-connected combinations of bidirectional switches, which are connected to be switched in synchrony with each other to thereby operate as a single bidirectional switch.

According to some but not necessarily all embodiments, there is provided: A power conversion method, comprising the repeated actions of: a) totally disconnecting a link transformer from the outside world, to thereby change the voltage across windings of the link inductor; and then driving energy into the link transformer using a first phase leg, which includes two bidirectional switches which each comprise a series combination of multiple double-independent-base contact bipolar transistors; b) totally disconnecting the link transformer from the outside world, to thereby again change the voltage of the link transformer; and then extracting energy from the link transformer through a second phase leg, which includes two bidirectional switches which each comprise a series combination of double-independent-base-contact bipolar transistors; wherein both phase legs are turned on and turned off under approximately zero voltage.

According to some but not necessarily all embodiments, there is provided: A power converter, comprising: a plurality of phase legs each connected to a respective line of a first external power connection; each said phase leg comprising two fully bidirectional switching devices, so that the line connected to that phase leg can either source or sink current to either terminal of a link inductor which is paralleled by a capacitor; a plurality of phase legs each connected to a respective line of a second external power connection; each said phase leg comprising two bidirectional switching devices, so that the line connected to that phase leg can either source or sink current to either terminal of the link inductor; control circuitry which is connected to drive said switches so that said link inductor is coupled to each said line of said first and second ports at least twice, with opposite polarities, during each full cycle of AC oscillation of said link inverter; wherein the bidirectional switches on at least one said phase leg each comprise a series-connected combination of bidirectional switches which are connected to be switched in synchrony with each other to thereby operate as a single bidirectional switch.

### MODIFICATIONS AND VARIATIONS

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

In presently-preferred sample embodiments, phase legs can have four or six stacked bidirectional switches. In other embodiments, this can be different.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

Those of ordinary skill in the relevant fields of art will recognize that other inventive concepts may also be directly or inferentially disclosed in the foregoing. The claims as filed are intended to be as comprehensive as possible, and NO subject matter is intentionally relinquished, dedicated, disclaimed, or abandoned.

What is claimed is, among others (and, without exclusion, in addition to any other points which are indicated herein as inventive and/or surprising and/or advantageous):

1. A power conversion method, comprising the repeated actions of:
a1) totally disconnecting a link inductor from external connections, to thereby change the voltage of the link inductor; and then
a2) driving energy into the link inductor using a first phase leg, which includes a bidirectional switch selectably connecting a respective outside line to a first terminal of the link inductor, and also another bidirectional switch selectably connecting the same outside line to a second terminal of the link inductor;
b1) totally disconnecting the link inductor from external connections, to thereby again change the voltage of the link inductor; and then
b2) extracting energy from the link inductor through a second phase leg, which includes bidirectional switches selectably connecting another respective outside line to the first or second terminals of the link inductor;
wherein step a1 is prolonged sufficiently that turn-on at the start of step a2 happens under approximately zero voltage; and wherein step b1 is prolonged sufficiently that turn-off at the start of step b2 happens under approximately zero voltage;
wherein at least one of the phase legs includes two series-connected combinations of bidirectional switches, which are connected to be switched in synchrony.

2. The power conversion method of claim 1, wherein said bidirectional switches are B-TRANs.

3. The power conversion method of claim 1, wherein the link inductor is paralleled by a capacitor which remains connected to the link inductor during said steps a1) and b1).

4. The power conversion method of claim 1, wherein the link inductor comprises a transformer.

5. The power conversion method of claim 1, wherein the link inductor comprises a transformer; and wherein the transformer is shunted by a capacitor which remains connected to the transformer during said steps a1) and b1).

6. The power conversion method of claim 1, wherein each said series-connected combination of bidirectional switches comprises at least three bidirectional switches.

7. A power conversion method, comprising the repeated actions of:
a1) totally disconnecting a link transformer from the outside world, to thereby change the voltage across windings of the link transformer; and then
a2) driving energy into the link transformer using a first phase leg, which includes a bidirectional switch selectably connecting a respective outside line to a first terminal of the link transformer, and also another bidirectional switch selectably connecting the same outside line to a second terminal of the link transformer;
b1) totally disconnecting the link transformer from the outside world, to thereby again change the voltage of the link transformer; and then
b2) extracting energy from the link transformer through a second phase leg, which includes two bidirectional switches selectably connecting another respective outside line to selectable terminals of the link transformer;
wherein step a1 is prolonged sufficiently that turn-on at the start of step a2 happens under approximately zero voltage; and wherein step b1 is prolonged sufficiently that turn-off at the start of step b2 happens under approximately zero voltage;
and wherein at least one of the phase legs, but not both, includes two series-connected combinations of bidirectional switches, which are connected to be switched in synchrony with each other to thereby operate as a single bidirectional switch.

8. The power conversion method of claim 7, wherein said bidirectional switches are B-TRANs.

9. The power conversion method of claim 7, wherein the link inductor is paralleled by a capacitor which remains connected to the link inductor during said steps a1) and b1).

10. The power conversion method of claim 7, wherein each said series-connected combination of bidirectional switches comprises at least three bidirectional switches.

11. A power conversion method, comprising the repeated actions of:
a) totally disconnecting a link transformer from the outside world, to thereby change the voltage across windings of the link inductor; and then driving energy into the link transformer using a first phase leg, which includes two bidirectional switches which each comprise a series combination of multiple double-independent-base contact bipolar transistors;
b) totally disconnecting the link transformer from the outside world, to thereby again change the voltage of the link transformer; and then extracting energy from the link transformer through a second phase leg, which includes two bidirectional switches which each comprise a series combination of double-independent-base-contact bipolar transistors;
wherein both phase legs are turned on and turned off under approximately zero voltage.

12. The power conversion method of claim 11, wherein said bidirectional switches are B-TRANs.

13. The power conversion method of claim 11, wherein the link inductor is paralleled by a capacitor which remains connected to the link inductor during said steps a1) and b1).

14. The power conversion method of claim 11, wherein the link inductor comprises a transformer.

15. The power conversion method of claim 11, wherein the link inductor comprises a transformer; and wherein the transformer is shunted by a capacitor which remains connected to the transformer during said steps a1) and b1).

16. The power conversion method of claim 11, wherein each said series-connected combination of bidirectional switches comprises at least three bidirectional switches.

17. A power converter, comprising:
a plurality of phase legs each connected to a respective line of a first external power connection; each said phase leg comprising two fully bidirectional switching devices, so that the line connected to that phase leg can either source or sink current to either terminal of a link inductor which is paralleled by a capacitor;
a plurality of phase legs each connected to a respective line of a second external power connection; each said phase leg comprising two bidirectional switching devices, so that the line connected to that phase leg can either source or sink current to either terminal of the link inductor;
control circuitry which is connected to drive said switches so that said link inductor is coupled to each said line of said first and second ports at least twice, with opposite polarities, during each full cycle of AC oscillation of said link inverter;
wherein the bidirectional switches on at least one said phase leg each comprise a series-connected combination of bidirectional switches which are connected to be switched in synchrony with each other to thereby operate as a single bidirectional switch.

18. The power converter of claim 17, wherein said bidirectional switches are B-TRANs.

19. The power converter of claim 17, wherein the link inductor comprises a transformer.

20. The power converter of claim 17, wherein each said series-connected combination of bidirectional switches comprises at least three bidirectional switches.

21. The power converter of claim 17, further comprising a resistive ladder connected in parallel to each said series-connected combination of bidirectional switches.
